(19) United States
(12) Patent Application Publication
(10) Pub. No.: US 2026/0301501 A1
(43) Pub. Date: Oct. 1, 2026

(54) PAPER SHEET HANDLING DEVICE WITH BEZEL POSITION ADJUSTER

(71) Applicant: JAPAN CASH MACHINE CO., LTD., Osaka (JP)

(72) Inventor: Kenichi ITO, Osaka (JP)

(21) Appl. No.: 19/629,963

(22) Filed: Mar. 26, 2026

(30) Foreign Application Priority Data
Mar. 31, 2025 (JP) JP2025-058209

(51) Int. Cl. G07D 11/14; G07D 11/40

(52) U.S. Cl. CPC G07D 11/14; G07D 11/40

(57) ABSTRACT

Paper sheet handling device with alignment of the position of a bezel attached to a door of a banknote handling device with a body of banknote handling device. A banknote handling device includes a bezel that has a banknote input port to which banknotes are input and that is attached to a door of an enclosure, a banknote separation transport device body that has a banknote receiving port receiving the banknotes input from the banknote input port and that is housed in the enclosure, and an adjuster (flanged bushes, an elastic biasing member) that positionally adjusts the banknote input port and the banknote receiving port to be communicated with each other in a normal positional relation during a closing operation of the door.

### CROSS REFERENCE TO RELATED APPLICATION

This application is based upon and claims the benefit of priority to Japanese Patent Application No. 2025-058209, filed on Mar. 31, 2025, with the Japanese Patent Office, the entire contents of which are incorporated herein by reference in its entirety.

### FIELD

The embodiments of the present invention relate to a paper sheet handling device.

### BACKGROUND

A banknote handling device such as a banknote deposit machine, a banknote counting machine, various types of automatic vending machines, or a game media dispensing machine in a game hall takes out a banknote one-by-one from a bundle of banknotes set on a deposit part and transports the banknote to store the banknote in a cashbox. For example, a banknote handling device installed in a retail store receives and collectively manages banknotes collected from cash registers. Banknotes taken out from a bundle of banknotes are subjected one-by-one to judgment of authenticity, denomination, and the like by a recognition device and a banknote that is judged to be acceptable is stored in the cashbox.

A bulk document feeder (a document processing device) of U.S. Pat. No. 8,662,490 includes a bulk feeder module including a pickup part that takes out a banknote one-by-one from a paper sheet bundle set on a tray and is configured to transport the banknote, a separating part that separates multi-fed paper sheets, and a drawing part that draws out a paper sheet separated by the separating part and transports the paper sheet downstream, an acceptor module that transports a paper sheet having passed through the drawing part toward a cashbox, and the cashbox arranged immediately below these modules. The bulk feeder module is removably combined with the accepter module. A door that enables an access to the cashbox is arranged to close the front surface of the bulk feeder module. A narrow opening that receives paper sheets on the tray is formed on the door. A bezel including the tray is attached to the outer side of the opening and detached therefrom.

To facilitate deposit processing including reception, recognition, and counting of banknotes in U.S. Pat. No. 8,662,490, banknotes from outside needs to be smoothly received by the bulk feeder module. For this purpose, the positions of the bezel and the bulk feeder module need to be aligned with each other in a positional relation where a banknote jam is not caused. The same holds for a case where a banknote handling device dispenses banknotes. However, in U.S. Pat. No. 8,662,490, it is unclear how to align the position of the bezel attached to a door with the bulk feeder module.

### SUMMARY OF THE INVENTION

The embodiments of the present invention have been made in view of the above problems and have an object to align the position of a bezel attached to a door of a paper sheet handling device that processes paper sheets such as banknotes with the body of the paper sheet handling device.

In order to solve the above problems, a paper sheet handling device according to the embodiments of the present invention include a bezel that has a paper sheet passing port allowing paper sheets to pass, and that is attached to a door of an enclosure, a paper sheet handling device body that has a paper sheet transfer port allowing the paper sheets to be transferred to/from the paper sheet passing port, and that is housed in the enclosure, and an adjuster that positionally adjusts the paper sheet passing port and the paper sheet transfer port to be communicated with each other in a normal positional relation during a closing operation of the door.

According to the embodiments of the present invention, it is possible to align the position of a bezel attached to a door of a paper sheet handling device with the body of the paper sheet handling device.

### BRIEF DESCRIPTION OF DRAWINGS

FIG. 1A is an exterior perspective view of one example of a paper sheet separation transport device according to the embodiments of the present invention;

FIG. 1B is an exterior perspective view of an enclosure according to the embodiments of the present invention;

FIG. 2A is an exterior perspective view of the paper sheet separation transport device according to the embodiments of the present invention;

FIG. 2B is a vertical sectional view illustrating an internal configuration of the paper sheet separation transport device according to the embodiments of the present invention;

FIG. 3 is a perspective view illustrating a specific configuration example of a set-out part, a separating part, and a drawing transport part according to one embodiment of the present invention;

FIG. 4A is an explanatory diagram illustrating attached and detached structures of a bezel body according to the embodiments of the present invention;

FIG. 4B is an explanatory diagram illustrating attached and detached structures of a bezel body according to the embodiments of the present invention;

FIG. 4C is an explanatory diagram illustrating attached and detached structures of a bezel body according to the embodiments of the present invention according to the embodiments of the present invention;

FIG. 5 is a perspective view illustrating a relation between a banknote separation transport device body and a bezel according to the embodiments of the present invention;

FIG. 6 is an exploded perspective view for explaining an attachment structure of the bezel to a door according to the embodiments of the present invention;

FIG. 7 is a partial sectional perspective view for explaining an attachment structure of a bezel bracket to the door according to the embodiments of the present invention;

FIG. 8A is a diagram for explaining movement of the bezel at the time of a closing operation of the door according to the embodiments of the present invention;

FIG. 8B is a diagram for explaining movement of the bezel at the time of a closing operation of the door according to the embodiments of the present invention;

FIG. 9A is a diagram for explaining movement of the bezel at the time of a closing operation of the door according to the embodiments of the present invention;

FIG. 9B is a diagram for explaining movement of the bezel at the time of a closing operation of the door according to the embodiments of the present invention;

FIG. 10A is a schematic diagram and partial enlarged views thereof for explaining a relation between a pilot pin and a receiving hole at a time point when the receiving hole starts receiving the pilot pin according to the embodiments of the present invention;

FIG. 10B is a schematic diagram and partial enlarged views thereof for explaining a relation between a pilot pin and a receiving hole at a time point when the receiving hole starts receiving the pilot pin according to the embodiments of the present invention illustrating a comparative example;

FIG. 11A is an explanatory diagram of movement of the bezel at the time of a closing operation of the door in a second embodiment of the present invention;

FIG. 11B is an explanatory diagram of movement of the bezel at the time of a closed operation of the door in a second embodiment according to the present invention;

FIG. 12A is an explanatory diagram of movement of the receiving holes and the pilot pins at the time of a closing operation of the door in a third embodiment according to the present invention;

FIG. 12B is an explanatory diagram of movement of the receiving holes and the pilot pins at the time of a closed operation of the door in a third embodiment according to the present invention; and

FIG. 13 is an exploded perspective view for explaining an attachment structure of the bezel to the door according to a fourth embodiment according to the embodiments of the present invention according to the present invention.

### DESCRIPTION OF EMBODIMENTS

The present invention will be described below in detail with embodiments illustrated in the drawings. Note that constituent elements, types, combinations, shapes, relative arrangements thereof, and the like described in the embodiments are not intended to limit the scope of the invention solely thereto and are merely explanatory examples unless otherwise specified.

### Descriptions of Basic Configuration

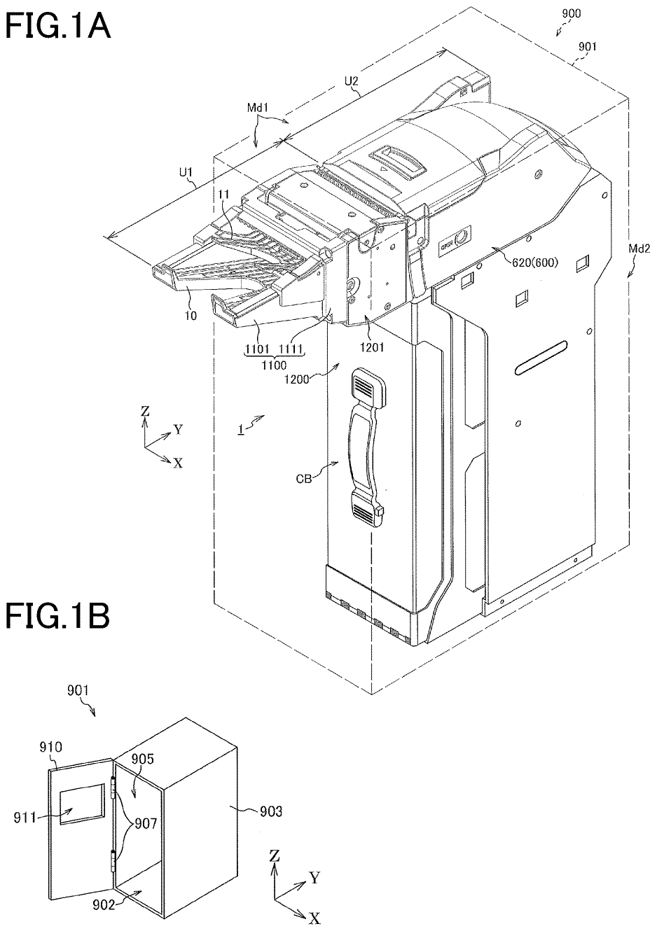

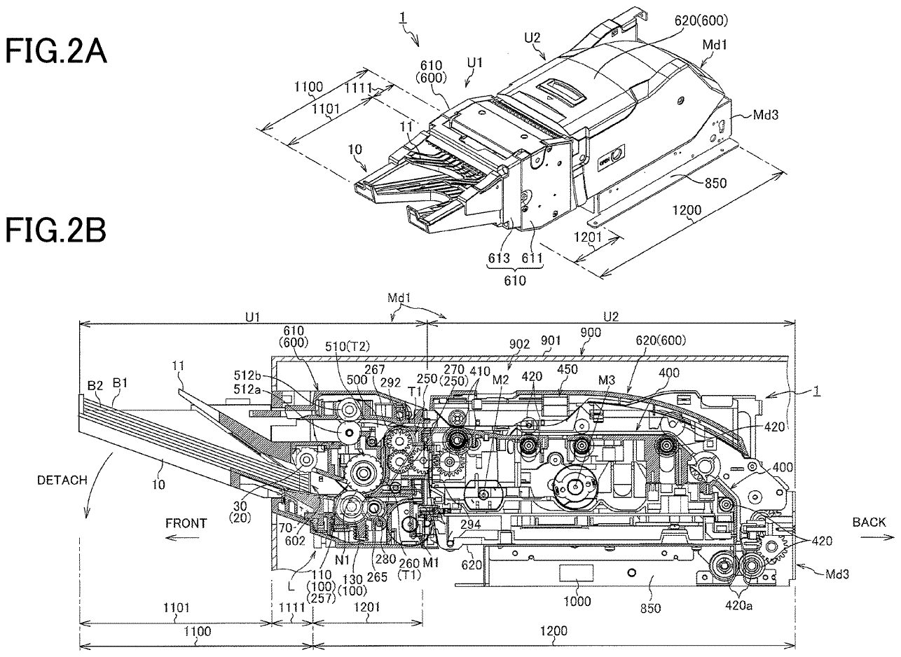

FIGS. 1A and 1B are exterior perspective views of one example of a paper sheet separation transport device according to the embodiments of the present invention. FIGS. 2A and 2B are diagrams illustrating the paper sheet separation transport device, where FIG. 2A is an exterior perspective view and FIG. 2B is a vertical sectional view illustrating an internal configuration.

While banknotes are mainly described as one example of paper sheets in the present specification, the present device is also applicable to separation and transport of paper sheets other than banknotes. The paper sheets also include sheets made of a resin or other materials as well as sheets made of paper.

A banknote separation transport device 1 is a unit that is installed in or provided along with a banknote handling device such as a banknote deposit machine, an automatic vending machine, a game media dispensing machine in a game hall to perform processing of receiving banknotes and discharging rejected banknotes.

The banknote separation transport device 1 is described in detail below.

The banknote separation transport device 1 schematically includes a first module Md1 including a deposit processing unit (a paper sheet reception processing unit) U1 and a storage processing unit (a paper sheet storage processing unit) U2, a downstream module (a second module Md2 or a third module Md3) removably coupled to the first module Md1, a controller (a CPU, an MPU, a ROM, a RAM, and the like) 1000 that controls various control targets, and the like.

As illustrated in FIGS. 1A and 1B, the second module Md2 is a module that has a cashbox (CB) incorporated therein and that receives banknotes discharged from the first module Md1 (the storage processing unit U2) to store the banknotes in the cashbox while putting the banknotes in order.

In addition to the second module Md2, the third module Md3, which does not include a cashbox and that performs reception processing of banknotes discretely discharged from the storage processing unit U2, is also connectable to the storage processing unit U2. Since being irrelevant to the gist of the embodiments of the present invention, the entire exterior configuration of the third module is not particularly illustrated and only a baseboard 850 as a connection part to the storage processing unit U2 is illustrated.

In the embodiment illustrated in FIGS. 2A and 2B and subsequent drawings, a configuration example in which the third module Md3 is connected downstream of the banknote storage processing unit U2, via the base board 850, is mainly described. However, exclusion of a configuration example in which the second module Md2 is connected thereto is not intended.

Hereinafter, each of the second module Md2 and the third module Md3 may also be referred to as “downstream module.”

The deposit processing unit U1 is a unit that receives a deposited banknote to transport the banknote to the storage processing unit U2 or discharges a rejected banknote returned from the storage processing unit U2 to outside the device.

The storage processing unit U2 includes a storage transport route (a storage transport mechanism) 400 that receives a banknote sent from the deposit processing unit U1 and transports the banknote to the second module Md2 or the third module Md3.

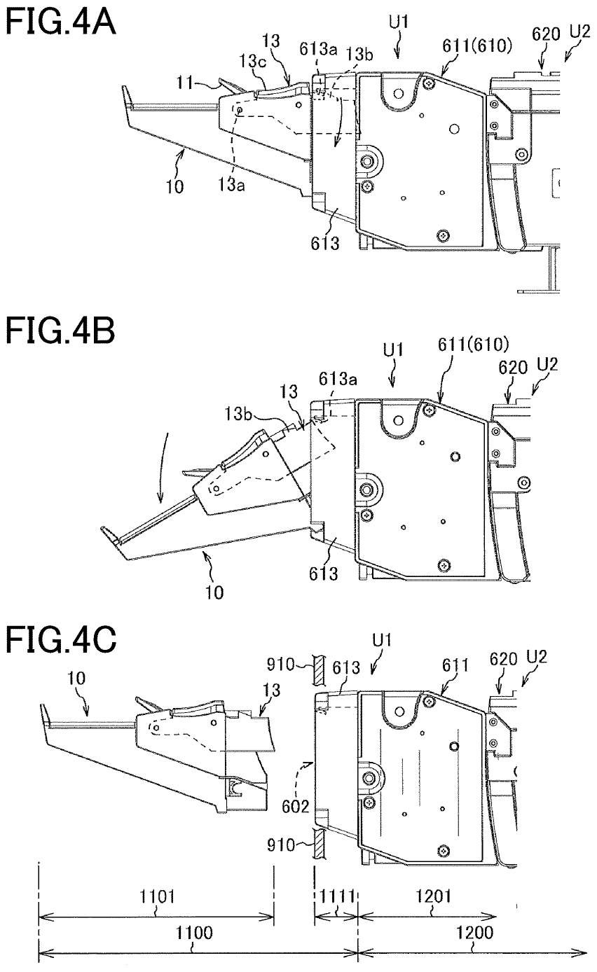

The deposit processing unit U1 includes a frame 600 including an opening 602 (FIG. 2B, FIG. 4C) for receiving banknotes on the front surface, a paper feed tray (a tray, a deposit part) 10 that is removably attached to the front surface of the frame (in front of the opening) and on which banknotes before being supplied into the frame are placed in a stacked state, a set-out part (a set-out roller 30 and a pick pusher 70) 20 that takes out a banknote one-by-one from the uppermost part of a banknote bundle on the paper feed tray 10 to supply the banknote into the frame, a separating part (a feed roller 110 and a brake roller 130) 100 that allows only a first banknote B1 to pass to send the banknote downstream and that blocks second and subsequent banknotes B2 from advancing when banknotes set out by the set-out part 20 are in a multi-fed state, a drawing transport part 250 that is located close to the feed roller 110 constituting the separating part 100 to form a drawing transport route 260 and that draws out one banknote B1 having a part remaining in the separating part 100 to send the banknote downstream (toward the storage processing unit U2) by rotating forward, and a first motor M1 that drives various driven members constituting the set-out part 20 and the separating part 100 (a set-out and separation mechanism 15).

The deposit processing unit U1 further includes a first transport route (a first transport mechanism) T1 that transports a banknote sent from the drawing transport part 250 toward the storage processing unit U2, a second transport route (a second transport mechanism) T2 that performs return transport to a return banknote storage tray (a return banknote accumulating part) 11 that receives banknotes having been reversely sent from the storage transport route 400 of the storage processing unit U2, and a flapper 500 that is arranged at a branch point between these transport routes T1 and T2 to switch the banknote transport direction to the first transport route T1 or the second transport route T2.

Each of the first transport route T1 and the second transport route T2 include not only a mere transport path but also transport components such as transport rollers, gears, a tracking sensor arranged along the transport path.

The frame 600 includes a frame 610 of the deposit processing unit U1 and a frame 620 of the banknote storage processing unit U2. The frame (a fixed part) 610 of the deposit processing unit U1 includes a frame body (a fixed part) 611, and a bezel bracket 613 fixed to a front-surface opening of the frame body 611. A bezel body 1101 (FIG. 4C) including the paper feed tray 10 is attached to or detached from the bezel bracket 613.

FIGS. 4A, 4B, and 4C are explanatory diagrams illustrating attached and detached structures of the bezel body 1101. A catch click member 13 has one end part supported about an axis by a shaft 13a, located at an appropriate place in an upper part of the paper feed tray 10, and is configured to be rotationally movable in the upper-lower direction. A click 13b is provided to be upturned on the other end of the catch click member 13. The catch click member 13 is biased upward around the shaft 13a by a spring (not illustrated).

In the attached state of FIG. 4A, the click 13b is caught on a caught part 613a provided on an upper portion in the opening of the bezel bracket 613. When a pressing part 13c, provided on an upper part of the catch click member 13 is pushed in the state of FIG. 4A, the other end part where the click 13b is provided, lowers against the spring and separates from the caught part 613a (FIG. 4B). Accordingly, the paper feed tray 10 can be detached from the bezel bracket 613 as illustrated in FIG. 4C.

This example is described assuming that the return banknote storage tray 11 is assembled to the paper feed tray 10 and that the bezel body 1101 is configured to include both the return banknote storage tray 11 and paper feed tray 11. The attached and detached structures of the paper feed tray are not limited thereto.

A flapper (a sort unit) 500 acts to switch the banknote transport direction. The flapper 500 is a sort unit that guides a banknote having been transported to the position of the second reverse rollers 267 by the drawing belts 270 toward the storage transport route 400 and that guides a banknote transported reversely from the storage transport route 400 toward the return transport route 510. The flapper 500 that is supported about an axis by a pivot shaft 500a provided on a lower part to be rotationally movable in the upper-lower direction closes a passage from the drawing transport route 260 toward the storage transport route 400 by lowering a right end part (a leading end part) by the own weight balance of the flapper 500 in normal times (an initial attitude). Meanwhile, at the time of passing of a banknote lifted by the drawing belts 270, the right end part of the flapper 500 is pushed up by the banknote and the flapper 500 allows the banknote to move to the right. When the back end of the banknote passes the right end part of the flapper 500, the flapper 500 returns to the initial attitude.

When a banknote once having moved into the storage transport route 400 is judged by a recognition unit 450 to be unacceptable, the controller 1000 causes motors M2 and M3 to reversely rotate transport members 410 and 420 constituting the storage transport route 400, thereby transporting the banknote reversely toward the flapper 500. Since the flapper 500 is in the initial attitude at this stage, the rejected banknote passes on the flapper 500 from the back-end part to enter the return transport route 510. A return roller pair (transport members) 512a and 512b are arranged on the return transport route and are driven by the second motor M2 in a direction to discharge a banknote. The return banknote storage tray 11 is placed at the terminal end part of the return transport route 510 and discharged return banknotes are sequentially stored therein.

The return transport route 510 is arranged above and substantially in parallel to a set-out route from the set-out part toward the separating part, and the return banknote storage tray 11 is arranged above and substantially in parallel to the paper feed tray 10. In the present invention, the first motor M1 drives the set-out and separation mechanism (the separation unit) 15, and the transport members 512 and the like of the return transport route are driven by the second motor M2. Therefore, these components do not interfere with each other and a stable separation operation and a stable return transport operation can be realized.

The storage processing unit U2 includes the storage transport route (a storage transport mechanism, a storage transport part) 400 that receives a banknote B transported by the drawing belts 270 constituting the drawing transport part 250 to transport the banknote to the inside, the recognition unit 450 that optically judges the denomination, the authenticity, and the like of a banknote transported downstream on the storage transport route 400, and the like. A banknote judged to be acceptable as a result of the recognition is transported downstream to be stored in the cashbox (CB) included in the second module Md2 (or stored in the third module Md3), and a banknote (a rejected banknote) judged to be unacceptable is transported reversely to be discharged to the return banknote storage tray 11 through the deposit processing unit U1. The banknote storage processing unit U2 further includes the second motor M2 that drives the transport members (such as a gear and a roller) 410 located upstream of the storage transport route 400 and the return roller pair 512, and the third motor M3 that drives the transport members (such as a gear and a roller) 420 located downstream of the storage transport route 400. The third motor M3 drives the transport roller group 420 located from a midstream part to a downstream part of the storage transport route 400. A transport roller pair 420a located at the most downstream part of the storage transport route 400 is a unit that discharges a banknote to the downstream module Md2 or Md3.

Configurations and operations of set-out part 20, separating part 100, and drawing transport part 250. Configurations and operations of the set-out part 20, the separating part 100, and the drawing transport part 250 are described next based on FIGS. 2 to 4 and the like.

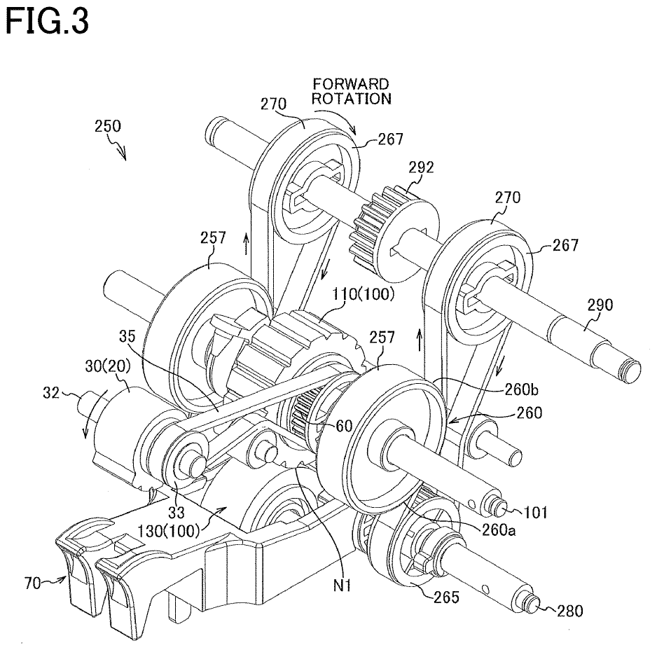

FIG. 3 is a perspective view illustrating a specific configuration example of the set-out part 20, the separating part 100, and the drawing transport part 250 according to one embodiment of the present invention.

As illustrated in FIGS. 2A and 2B and FIG. 3, the set-out roller 30 constituting the set-out part 20 is fixed to a shaft part 32 that rotates by drive from the first motor M1, and a downstream timing pulley 33 is coaxially fixed to the set-out roller 30 on the side of one surface thereof. The downstream timing pulley 33 receives the drive from the first motor M1 via a timing belt 35 provided endlessly in a tensioned manner between the downstream timing pulley and an upstream timing pulley 60 provided on the side of the feed roller 110.

The separating part 100 includes a feed roller shaft 101 driven by the first motor M1, the feed roller 110 that is supported by the feed roller shaft 101 to be rotatable on the axis thereof, and that is brought into contact with a surface of a first banknote set out by the set-out part 20 to transport the first banknote when rotating forward, and the brake roller (a frictional separating member) 130 that forms a separation nip part N1 with the feed roller 110 to block second and subsequent banknotes from advancing. The feed roller 110 may have a configuration in which the axis thereof is fixed to the feed roller shaft 101 to enable the both thereof to rotate together. However, in a case where a backlash formation unit to provide a backlash in a circumferential direction with the feed roller shaft 101 is adopted, the feed roller 110 is not necessarily directly fixed to the feed roller shaft 101. However, since the backlash formation unit is not directly related to the gist of the present invention, detailed explanation of the configuration and the like thereof is omitted.

The drawing transport part 250 includes at least two idle rollers (freely rotating members) 257-1, 257-2 that are supported about an axis (unfixed in the rotation direction and fixed in the position in the axial direction) at feed roller shaft portions on both sides of the feed roller 110 in the axial direction to be rotatable, and endless drawing belts 270-1, 270-2 that are each in contact with the curved outer circumferential surface of an associated idle roller 257-1, 257-2 to form the curved drawing transport route (a drawing nip part) 260 and that rotate (rotate forward) in the drawing direction to turn a first banknote in a direction (obliquely upward) intersecting with the direction of set-out by the set-out part (the direction in which the banknote passes the separation nip part N1) in cooperation with the idle rollers 257-1, 257-2 to transport the banknote.

Each of the drawing belts 270-1, 270-2 is endlessly provided in a tensioned manner by a first reverse roller (a driven roller) 265 that is arranged to form the drawing transport route 260 with the outer circumferential surface of the associated idle roller 257-1, 257-2, and the second reverse roller (a driving roller) 267. The first reverse rollers 265 form a banknote introducing part 260a of the drawing transport route between the drawing belts 270-1, 270-2 and the associated idle rollers 257-1, 257-2. The second reverse rollers 267 reverse the associated drawing belts 270-1, 270-2 causing a banknote introduced from the banknote introducing part 260a to be transported toward the storage transport route 400 after passing through a downstream end part (a banknote discharge part) 260b of the drawing transport route. Each of the first reverse rollers 265 has an axis rotatably supported in a free unfixed state by a first shaft 280 that is rotationally driven by the first motor M1. That is, the first reverse rollers 265 are driven rollers that do not rotate to follow the rotation of the first shaft 280. The drawing belts 270-1, 270-2 are driven by the rotation of the associated second reverse rollers 267 functioning as driving rollers.

The feed roller 110 and the idle rollers 257 are coaxially assembled on the feed roller shaft 101 and the outer circumferential surfaces thereof are located at substantially the same positions in the radial direction. Therefore, while the feed roller 110 is slightly in contact with a central portion of a banknote, there is no positive grip, and a large transport resistance is not produced.

The drawing belts 270-1, 270-2 draw up a banknote having passed through the separation nip part N1 and the feed roller 110 is rotationally driven by a minimum necessary angle only at the time of separation. Accordingly, the feed roller 110 is not involved with the operation of drawing up a banknote after the separation and does not have a function to draw up a banknote.

In one embodiment, it is preferable that the circumferential surfaces of the idle rollers 257-1, 257-2 are decreased in the friction to such an extent that slip occurs between the circumferential surfaces and a banknote. The circumferential surfaces of the drawing belts 270-1, 270-2 are increased in the friction to such an extent that slip is unlikely to occur between the circumferential surfaces and a banknote.

The idle rollers 257-1, 257-2 function to bring the drawing belts 270-1, 270-2 into contact with a banknote, and a banknote is pressed against the outer circumferential surfaces of a low frictional resistance of the idle rollers 257-1, 257-2 due to the tension applied to the drawing belts 270-1, 270-2, and produces a transport grip force in cooperation with the frictional resistances of the drawing belts 270-1, 270-2.

In one embodiment, the idle rollers 257-1, 257-2 are made of a rigid material that is not flexurally deformed by a pressure from the drawing belts 270-1, 270-2. In one embodiment, it is preferable that the width of the outer circumferential surface of each of the idle rollers 257-1, 257-2 is substantially the same as that of the associated drawing belt in the form of a narrow band or wider than the width of the drawing belt 270-1, 270-2.

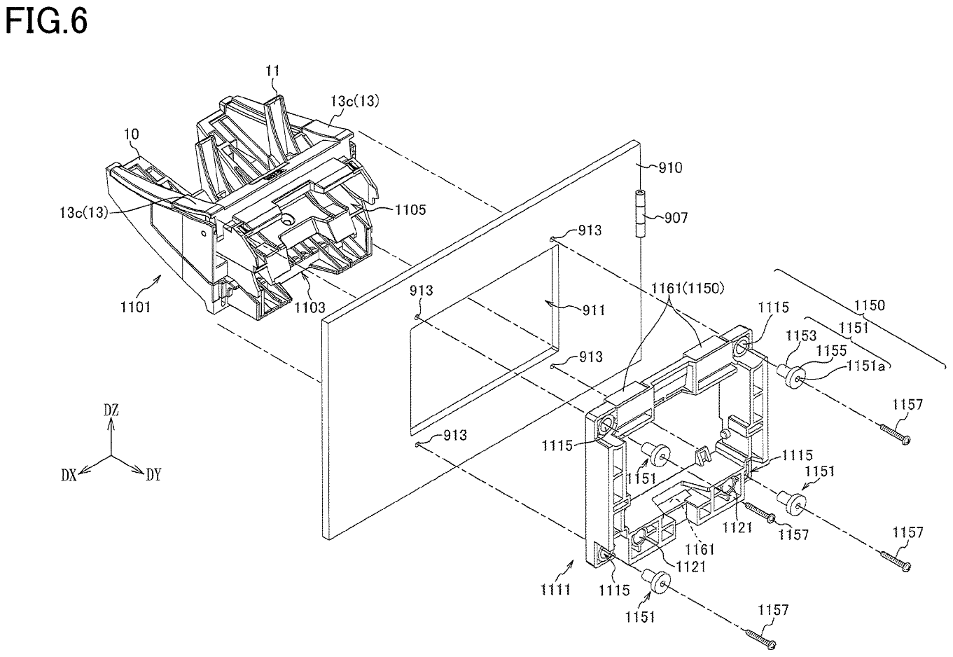

While being a direction upward by about 90 degrees in FIG. 6, the direction intersecting with the direction of set-out by the set-out part widely includes directions bent or curved upward (non-parallel directions) with respect to the surface direction of banknotes set out on the paper feed tray 10.

The banknote introducing part 260a of the drawing transport route is formed at a portion where the drawing belt 270-2 having been turned to the upper direction by the first reverse roller 265 rotating in the clockwise direction is first brought into contact with the outer circumferential surface of the feed roller 110. One banknote having passed through the separation nip part N1 is brought into contact with the drawing belt surface (a portion inclined to the obliquely upper right direction in FIGS. 2A and 2B and other figures) before the banknote introducing part, so that the banknote is smoothly drawn obliquely upward to be immediately drawn into the banknote introducing part 260a.

The banknote having passed through the banknote discharge part 260b is transported upward by the drawing belt 270-2 and is subsequently introduced to the inlet of the storage transport route 400 along a reverse route between the outer circumferences of the second reverse rollers 267 and a transport guide member (not illustrated).

The idle rollers 257-1, 257-2 held by the tension of the drawing belts 270-1, 270-2 idle with respect to the feed roller shaft 101 and accordingly are not dependent on the driving or the rotation speed of the feed roller shaft 101. While the feed roller 110 and the idle rollers 257-1, 257-2 are arranged on the same feed roller shaft 101, these rollers 257-1, 257-2 are arranged at different positions in the axial direction, whereby the separation nip part N1 as a separation point and the drawing transport route 260 (the banknote introducing part 260a) as a pull-out point can be separated. Furthermore, as a result of configuring the drawing transport route 260 with the traveling drawing belts 2701, 270-2, the distance between the separation nip part N1 and the banknote introducing part 260a in the side surface view can be freely set to any minimum necessary value. Specifically, great reduction of the distance, for example, to be smaller than the diameter or the radius of the feed roller 110 is possible.

The pick pusher 70 has a base end part fixedly supported by the first shaft 280, thereby lifting the distal end and pushing upward the banknote bundle on the paper feed tray 10 toward the set-out roller 30 to bring the banknote bundle into contact with the set-out roller 30 when the first shaft 280 rotationally moves clockwise. When the first shaft 280 is reversely rotated, the pick pusher 70 descends. A torque limiter (not illustrated) is placed between the pick pusher 70 and the first shaft 280 and is slipped to prevent the banknote bundle from being pushed up with an excessive force.

Each of the second reverse rollers (driving rollers) 267 has an axis fixedly supported by a second shaft 290 arranged above and in parallel to the first shaft 280, and a transmission gear 292 is fixed on the second shaft at an intermediate position between the two second reverse rollers 267. The transmission gear 292 is connected to mesh with a gear group 294 that transmits a rotational drive force from the second motor M2. Therefore, the drawing transport part 250 is driven by the second motor M2 that drives upstream transport members of the storage transport route 400.

As described above, according to the embodiments of the present invention, the set-out part 20 and the separating part 100 are driven by the first motor M1 while the drawing transport part 250 is driven by the second motor M2 via the gear groups 294 and 292. Therefore, the set-out and separating operation and the drawing transport operation can be driven and controlled independently.

Although the length of banknotes varies by country, if the timing for drawing a banknote from the separating part is uniform, the banknote cannot be drawn out at an appropriate timing corresponding to the difference in the length of banknotes. With the embodiments of the present invention, since drive of the drawing transport part 250 is performed by the second motor M2 independent of drive of the separating part, a banknote can be drawn out at an appropriate timing after separation corresponding to the difference in conditions such as the length of the banknote. Accordingly, limitations arising from the difference in conditions are reduced and thus reliable drawing can be made.

Since the transport by the drawing belts 270-1, 270-2 that travel endlessly is adopted to pull out a banknote by the drawing transport part 250, a nonlinear transport path where the drawing transport part is bent (curved) upward with respect to the transport direction of the set-out part and the separating part can be formed to realize downsizing. Also in this downsized configuration, the flexibility in arrangement of components can be increased, and reliable banknote separation and drawing transport can be performed.

Even in such a nonlinear downsized device configuration where the banknote transport route is bent or curved in a substantially L-shaped manner, the set-out and separation mechanism 15 and the drawing transport part 250 can be independently controlled in the speed and the operation by driving the drawing transport part 250 with the second motor M2 that drives another driving mechanism adjacent thereto, that is, the upstream transport member 410 of the storage transport route 400, and a reliable separation and drawing transport operation can be performed.

In order to reliably draw out a banknote separated by the separating part 100, the transport speed (drive force) at the time of drawing needs to be higher (larger) than the transport speed (drive force) at the time of separation. This transport speed difference can be realized by a mechanical structure such as gears using one drive source, without provision of individual drive sources. However, in such a case, for example, when the drawing speed of the drawing transport part 250 is to be 30% higher than the transport speed of the separating part 100, this speed difference cannot be realized unless a combination of many complicated gears is adopted. In contrast thereto, with the embodiments of the present invention, the separating part and the drawing transport part are predetermined to be driven by the motors M1 and M2 independent of each other. Therefore, control of the speed difference can be executed considerably easily and freely without complicating the mechanical configuration or increasing the number of components. Furthermore, the second motor M2 is not a motor arranged in the deposit processing unit U1 but a motor arranged in the adjacent different banknote storage processing unit U2. Therefore, increase in the size of the deposit processing unit U1 can be prevented.

### Descriptions of Enclosure

As illustrated in FIGS. 1A and 1B, the banknote separation transport device 1 is received by an attachment part (a void for attachment) 902 provided in an enclosure 901 of a banknote handling device 900. The frame 610 of the deposit processing unit U1, the storage processing unit U2, and the cashbox (CB) are housed in the enclosure 901. The paper feed tray 10 and the return banknote storage tray 11 of the banknote separation transport device 1 are exposed outward from a window 911 provided on a door 910 of the enclosure 901.

The enclosure 901 includes an enclosure body 903 having therein the attachment part 902 being a hollow space, and the door 910 that opens and closes a one-surface opening (front-surface opening) 905 of the enclosure body 903. The window 911 that exposes the paper feed tray 10 and the return banknote storage tray 11 to outside is formed at an appropriate place in the surface of the door 910 to penetrate therethrough. The door 910 is a hinged door that is supported about an axis by a hinge part 907 provided at an appropriate place of the enclosure body 903 to be rotationally movable.

### First Embodiment

Hereinafter, the bezel bracket 613 (1111) and a portion of the deposit processing unit U1 located on an upstream side (a device exterior side) from the bezel bracket 613 in the banknote transport direction of the banknote separation transport device 1 are referred to as bezel 1100. The bezel 1100 includes the paper feed tray 10, the return banknote storage tray 11, the catch click member 13, and the bezel bracket 1111 in FIGS. 4A-4C. A part including the paper feed tray 10, the return banknote storage tray 11, and the catch click member 13 in the bezel 1100 is referred to as bezel body 1101.

A part of the deposit processing unit U1 except for the bezel 1100 is referred to as BNF (Bank Noter Feeder) unit 1201. The BNF unit 1201 is a unit located on a downstream side from the bezel bracket 1111. Further, units located on the downstream side (a device interior side) from the bezel bracket 1111 in the banknote transport direction are collectively referred to as banknote separation transport device body (paper sheet handling device body) 1200. The banknote separation transport device body 1200 includes the BNF unit 1201, the storage processing unit U2, and the cashbox (CB).

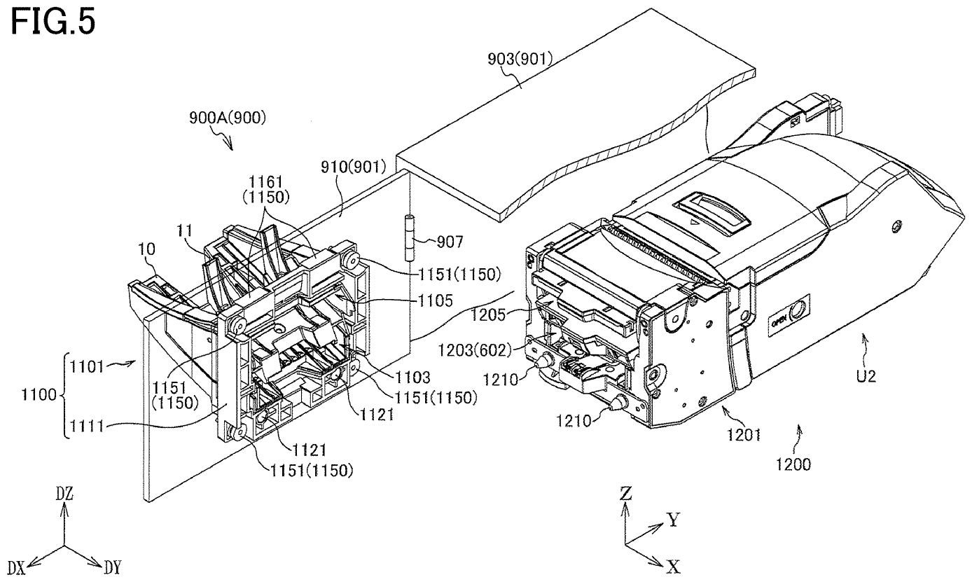

The banknote separation transport device (paper sheet handling device) 1 includes the bezel 1100 that has a banknote input port (paper sheet input port) 1102 to which a banknote is input and that is attached to the door 910 of the enclosure 901, the banknote separation transport device body 1200 that has a banknote receiving port (paper sheet receiving port) 1203 (FIG. 5) receiving a banknote input from the banknote input port 1103 and that is housed in the enclosure 901, and an adjuster (adjusting member) 1150 that adjusts the positions of the banknote input port 1103 and the banknote receiving port 1203 to be communicated with each other in a normal positional relation during a closing operation of the door 910.

### Door

The enclosure 901 has a substantially cuboid shape as one example. The door 910 has a substantially rectangular shape that opens and closes the one-surface opening 905 of a substantially rectangular shape provided on one surface (e.g.: the front surface) of the enclosure 901 as one example. The enclosure 901 includes the attachment part 902 that houses the banknote handling device 900 in a hollow space of the enclosure 901.

The door 910 is a hinged door and the enclosure 901 includes the hinge part (axially support part) 907 that supports the door 910 about an axis to be openable and closeable.

The door 910 is rotatably supported at an appropriate place of an end part in the right-left direction (the X direction) by the hinge part 907 that has a rotation axis extending in the upper-lower direction (the Z direction). The door 910 rotationally moves to open and close the one-surface opening 905 defined as a ZX plane.

The door 910 includes the window (opening) 911 formed in the plane to penetrate therethrough. The window 911 causes internal and external spaces of the enclosure 901 to be communicated with each other when the door 910 closes the one-surface opening 905. A banknote is taken in the banknote separation transport device body 1200 through the window 911.

The bezel bracket 1111 is attached to the window 911 to be movable relative to the door 910.

### Bezel

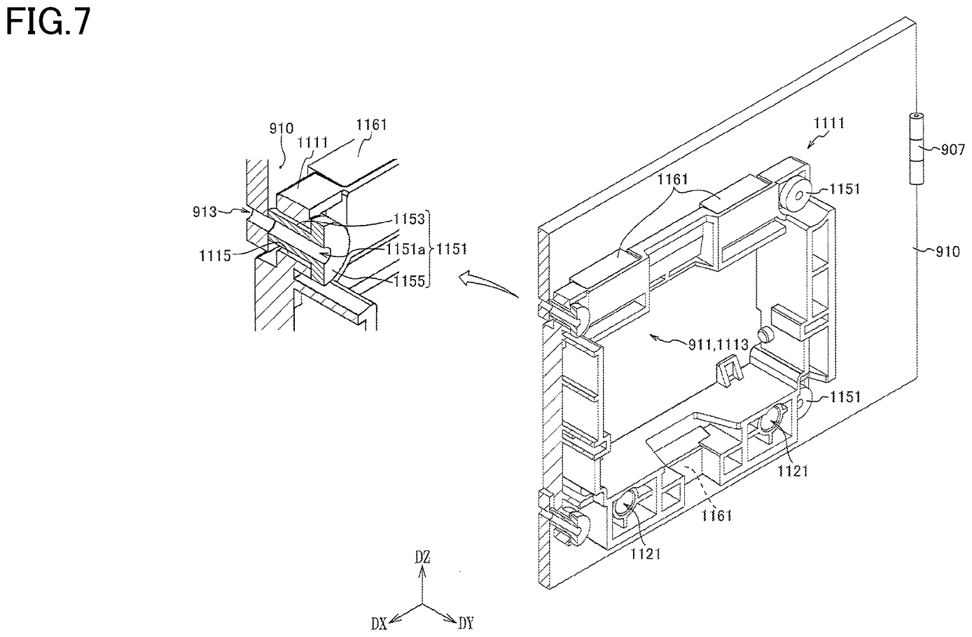

FIG. 5 is a perspective view illustrating a relation between the banknote separation transport device body and the bezel. FIG. 6 is an exploded perspective view of an area in the vicinity of the bezel 1100. FIG. 7 is a partial sectional perspective view for explaining an attachment structure of the bezel bracket 1111 to the door 910. In the drawings, an X-axis, a Y-axis, and a Z-axis represent axes with respect to the banknote separation transport device body 1200 or the enclosure body 903. A DX-axis, a DY-axis, and a DZ-axis in the drawings represent axes with respect to the door 910.

The bezel 1100 includes the bezel bracket 1111 attached on an inner side of the door 910, and the bezel body 1101 removably attached to the bezel bracket 1111 from outside of the door 910 through the window 911.

The bezel bracket 1111 is a frame body including a bracket opening 1113 communicated with the window 911. The bezel bracket 1111 is attached by the adjuster 1150 to the door 910 to be movable relative to the door 910.

The bezel body 1101 includes the paper feed tray 10 and the return banknote storage tray 11 described above. The bezel body 1101 also includes the banknote input port 1103 and a banknote return port 1105 communicated with the window 911 and the bracket opening 1113. The paper feed tray 10 and the return banknote storage tray 11 are protruded to outside of the enclosure 901 and a part of the bezel body 1101 including the banknote input port 1103 and the banknote return port 1105 is arranged inside the enclosure 901. The banknote input port 1103 and the banknote return port 1105 are collectively referred to as banknote passing port (paper sheet passing port).

The bezel body 1101 is integrated with the bezel bracket 1111 with the window 911 (the door 910) interposed therebetween (see FIGS. 4 to 6). The bezel body 1101 and the bezel bracket 1111 integrally move relative to the door 910. The direction of the relative movement will be described later.

As is understood from FIGS. 2A, 2B, 5, and 6, banknotes B1 and B2 placed on the paper feed tray 10 pass through the window 911, the bracket opening 1113, and the banknote input port 1103 to be taken in the banknote separation transport device body 1200 from the banknote receiving port 1203. As illustrated in FIGA. 2A and 2B, a banknote taken in from the banknote receiving port 1203 passes the first transport route T1 to be transported toward the storage processing unit U2.

As illustrated in FIGS. 2A and 2B, a return banknote having been reversely sent from the storage transport route 400 of the storage processing unit U2 is transported on the second transport route T2 (the return transport route 510) and is discharged from a banknote discharge port 1205. As illustrated in FIGS. 5 and 6, the return banknote discharged from the banknote discharge port 1205 passes through the banknote return port 1105, the bracket opening 1113, and the window 911 to be sequentially stored in the return banknote storage tray 11.

The banknote receiving port 1203 and the banknote discharge port 1205 are collectively referred to as a banknote transfer port (paper sheet transfer port).

### Adjuster

As illustrated in FIGS. 6 and 7, the adjuster 1150 includes flanged bushes 1151 fixed to an inner side of the door 910, and insertion holes 1115 that are formed at appropriate places of the bezel bracket 1111 to penetrate therethrough and into which shaft parts 1153 of the corresponding flanged bushes 1151 are inserted.

The adjuster 1150 is an attachment unit that attaches the bezel bracket 1111 to the door 910 and is an attachment unit that attaches the bezel body 1101 to the door 910 via the bezel bracket 1111.

The adjuster 1150 moves the bezel bracket 1111 in a direction intersecting with a banknote input direction (substantially the DY direction) (along a DZ-DX plane). The adjuster 1150 moves back and forth the bezel bracket 1111 along the banknote input direction (in the DY direction).

The flanged bushes 1151 are fastened to the inner side of the door 910 by fastening screws 1157. The shaft parts 1153 of the flanged bushes 1151 and the insertion holes 1115 are substantially columnar (or cylindrical) and the axis lines thereof extend in the banknote input direction (the DY direction).

A predetermined clearance is set between an outer circumferential surface of each of the shaft parts 1153 and an inner circumferential surface of the corresponding insertion hole 1115. The shaft part 1153 is loosely fitted (fitted with a clearance) in the insertion hole 1115. The flanged bushes 1151 support the bezel bracket 1111 to be movable relative to the door in the right-left direction (the DX direction) and the upper-lower direction (the DZ direction).

A flange part 1155 of the flanged bush 1151 has a larger diameter than the inside diameter of the insertion hole 1115 and is configured to prevent the bezel bracket 1111 from being separated from the flanged bush 1151.

The length in the axial direction (the length in the DY direction) of the shaft part 1153 of the flanged bush 1151 is set longer than the length in the axial direction of the insertion hole 1115. Accordingly, the bezel bracket 1111 is guided by the shaft parts 1153 of the flanged bushes 1151 and is supported to be movable relative to the door 910 in the front-back direction (the Y direction).

The clearance set between the shaft part 1153 of each of the flanged bushes 1151 and the corresponding insertion hole 1115 enables the bezel bracket 1111 to be appropriately inclined with respect to the door 910 in a DX-DY-DZ space.

### Elastic Biasing Member

The adjuster 1150 includes an elastic biasing member (elastic biasing unit) 1161 that elastically biases the bezel bracket 1111 to an initial position (or an initial attitude).

The initial position is a position of the bezel bracket 1111 with respect to the door 910 in an open state. The initial position can be set to a neutral position where the shaft parts 1153 does not abut inner surfaces of the corresponding insertion holes 1115 when the door 910 is open.

The bezel bracket 1111 is positioned at a site (a communicated position) where the banknote input port 1103 can be communicated with the banknote receiving port 1203 in a normal positional relation when closing the door 910 is completed. The normal positional relation is at a position where a banknote input from the banknote input port 1103 can smoothly pass through the banknote receiving port 1203 without causing a jam to be taken in the banknote separation transport device body 1200. In the banknote handling device 900, the position of the bezel bracket 1111 with respect to the door 910 at the time of completion of closing of the door 910 may be set to the neutral position described above. That is, the initial position may be set to be substantially the same as the communicated position.

On the other hand, the initial position and the communicated position of the bezel bracket 1111 with respect to the door 910 may be different.

Regarding elastic biasing of the bezel bracket 1111 to the initial attitude by the elastic biasing member 1161, the same as the elastic biasing of the bezel bracket 1111 to the initial position holds.

The initial attitude of the bezel bracket 1111 may be inclined with respect to an attitude where the banknote input port 1103 is communicated with the banknote receiving port 1203 in the normal positional relation.

In adjustment of the banknote input port 1103 with respect to the banknote receiving port 1203 to be in the normal positional relation, positional adjustment on the DZ-DX plane is more dominant than in the DY direction. Particularly, in the present example where the hinge part 907 includes a rotation axis extending in the DZ direction (the Z direction) and is arranged at an appropriate place (at one end part in the present example) in the DX direction, the positional adjustment in the DX direction is important.

The elastic biasing member 1161 illustrated in the drawings is constituted of a foamed resin (sponge). The elastic biasing member 1161 is sandwiched by the bezel bracket 1111 and the door 910. With the elastic biasing member 1161 being sponge, elastic force can be caused to act in the three-dimensional direction of DX-DY-DZ directions. Accordingly, the elastic biasing member 1161 of the present example elastically biases the bezel bracket 1111 toward the banknote separation transport device body 1200 when the door 910 is closed.

A coil spring, a leaf spring, rubber, a viscoelastic body, or other elastic materials can be used as the elastic biasing member. An elastic biasing member that elastically biases the bezel bracket 1111 to the initial position and an elastic biasing member that elastically biases the bezel bracket 1111 toward the side of the banknote separation transport device body 1200 may be one member or different members.

The elastic biasing member that elastically biases the bezel bracket 1111 to the initial position may be constituted of a plurality of elastic biasing members that pressurize the bezel bracket 1111 in different directions.

### Positioning of Device Body and Bezel

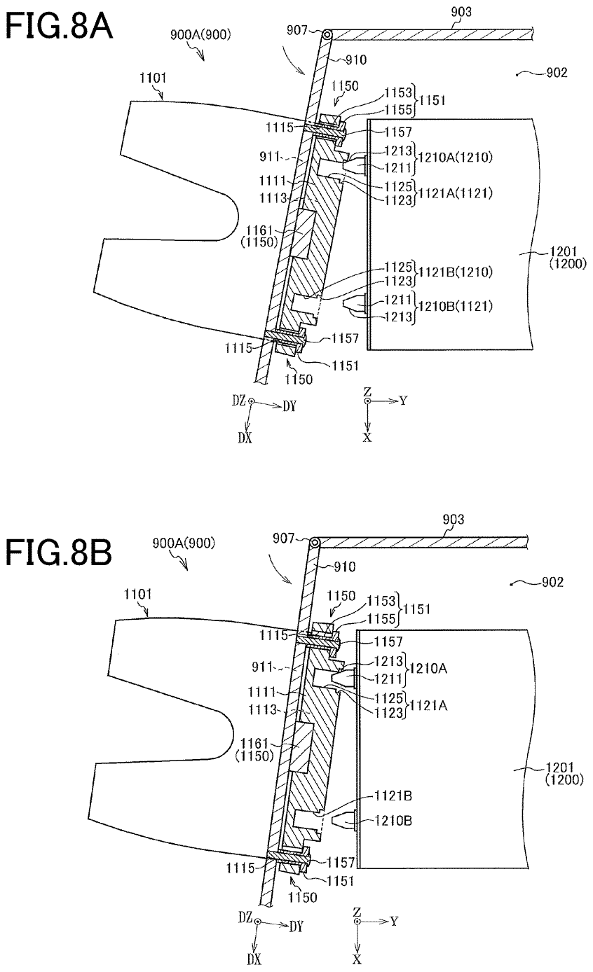

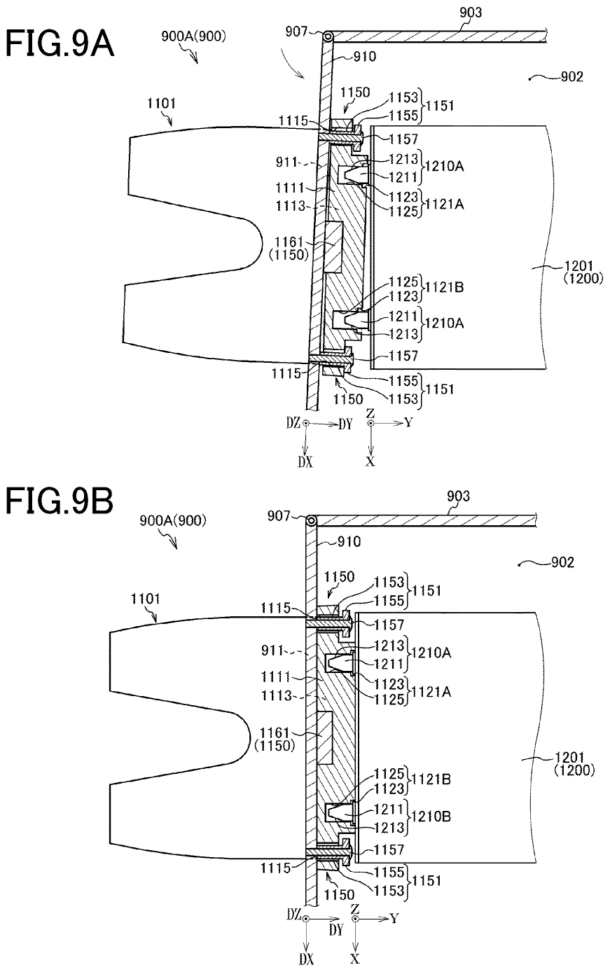

FIGS. 8A, 8B, 9A and 9B are diagrams for explaining movement of the bezel at the time of a closing operation of the door.

In the drawings, an X-axis, a Y-axis, and a Z-axis represent axes with respect to the banknote separation transport device body 1200 or the enclosure body 903. The X-axis, the Y-axis, and the Z-axis are fixed and the orientations thereof do not change regardless of whether the door 910 is opened or closed. The rotation axis of the hinge part 907 extends in the Z-axis direction.

In the drawings, a DX-axis, a DY-axis, and a DZ-axis represent axes with respect to the door 910. The DX-axis, the DY-axis, and the DZ-axis are set to directions that become substantially parallel to the X-axis, the Y-axis, and the Z-axis, respectively, when closing of the door 910 is completed.

The DX-axis and the DY-axis change orientations with respect to the X-axis and the Y-axis according to the opening degree of the door 910. The DZ-axis is an axis line direction of the hinge part 907 of the door 910. While there is a possibility that the DZ-axis is inclined with respect to the Z-axis during an operation of the door 910, the DZ-axis substantially maintains a state of being parallel to the Z-axis.

In FIGS. 8A, 8B, 9A and 9B, the DX-direction positions of the bezel with respect to the door 910 at the initial position and at a closed time are drawn to be the same for sake of explanatory convenience.

### Pins and Receiving Holes

The bezel bracket 1111 includes receiving holes (a first engaging part) 1121, 1121 on an opposed surface to the banknote separation transport device body 1200. The banknote separation transport device body 1200 includes pilot pins (a second engaging part) 1210, 1210 fixed on the front surface of the banknote separation transport device body to be protruded forward.

Each of the pilot pins 1210 is a rod-like body that includes a columnar part 1211 at a proximal end and a taper part 1213 at a distal end and that has an axis line extending in the Y direction. The outside diameter of the columnar part 1211 is substantially constant in the axial direction and the taper part 1213 has a tapered inclined shape.

Each of the receiving holes 1211 includes a large-diameter part 1123 at an entrance portion and includes an engaging part 1125 at an appropriate place in the axial direction. The large-diameter part 1123 has a larger diameter than other portions in the axial direction and facilitates receiving of the pilot pin 1210. The engaging part 1125 has a shape fitting to (mutually fitting with) the columnar part 1211 of the pilot pin 1210.

The pilot pins 1210, 1210 and the receiving holes 1121, 1121 are positioning units that guide the banknote input port 1103 to be in the normal positional relation with the banknote receiving port 1203 (FIGS. 8A, 8B, and 9A). The pilot pins 1210, 1210 are units that hold the banknote input port 1103 and the banknote receiving port 1203 in the normal positional relation when fitted in the receiving holes 1121, 1121 (FIG. 9B).

### Descriptions of Operation

When a pilot pin 1210 is brought into contact with an appropriate place of the corresponding receiving hole 1121 during a closing operation of the door 910 as illustrated in FIG. 8A, the adjuster 1150 moves the bezel bracket 1111 relative to the door 910 so as to fit the pilot pin 1210 in the receiving hole 1121 (FIGS. 8B, 9A, and 9B).

That is, when the door 910 is moved in the closing direction from an open state (FIG. 5), a pilot pin 1210A near the hinge part 907 starts being brought into contact with the large-diameter part 1123 of a receiving hole 1121A as illustrated in FIG. 8A. FIG. 8A illustrates a state where the pilot pin 1210A is in contact with the receiving hole 1121A while the bezel bracket 1111 has not been moved and is at the initial position. In this state, the axis line (the Y-axis direction) of the pilot pin 1210A and the axis line (the DX-axis direction) of the receiving hole 1121A are out of alignment. If the bezel bracket 1111 is fixed to the door 910, the pilot pin 1210A cannot enter the receiving hole 1121A.

In the present example, the bezel bracket 1111 is supported to be movable with respect to the door 910. Therefore, when the door 910 is closed further, the bezel bracket 1111 is pushed in the DX direction (toward the hinge part 907) by the pilot pin 1210A via the receiving hole 1121A as illustrated in FIG. 8B. Accordingly, the position of the bezel bracket 1111 is adjusted to facilitate entering of the pilot pin 1210A into the receiving hole 1121A.

In the present example, the bezel bracket 1111 is supported to be movable back and forth in the DY direction. The bezel bracket 1111 can three-dimensionally displace the attitude in a DX-DY-DZ space. Therefore, depending on the movement amounts of components of the bezel bracket 1111, the bezel bracket 1111 may be inclined with respect to the door 910 in a DX-DY plane as illustrated in FIG. 9A.

When the door 910 is inclined by gravity or the like, that is, the DZ-axis is inclined with respect to the Z-axis, the position of the bezel bracket 1111 in the DZ direction is appropriately adjusted by an action of the adjuster 1150 to fit the pilot pin 1210A into the receiving hole 1121A.

Finally, as illustrated in FIG. 9B, the columnar parts 1211 of the pilot pin 1210A and a pilot pin 1210B fit in the engaging parts 1125 of the receiving hole 1121A and a receiving hole 1121B in the normal positional relation. At this time, the positions of the banknote input port 1103 and the banknote receiving port 1203 (see FIG. 5) are aligned with each other. When the door 910 is completely closed, the elastic biasing member 1161 is compressed. The elastic biasing member 1161 presses the bezel bracket 1111 against the front surface of the banknote separation transport device body 1200. As a result, the banknote input port 1103 and the banknote receiving port 1203 are communicated with each other in a significantly close positional relation and smooth transport of banknotes therebetween is enabled.

### Effects of Present Embodiment

Comparison to Comparative Example

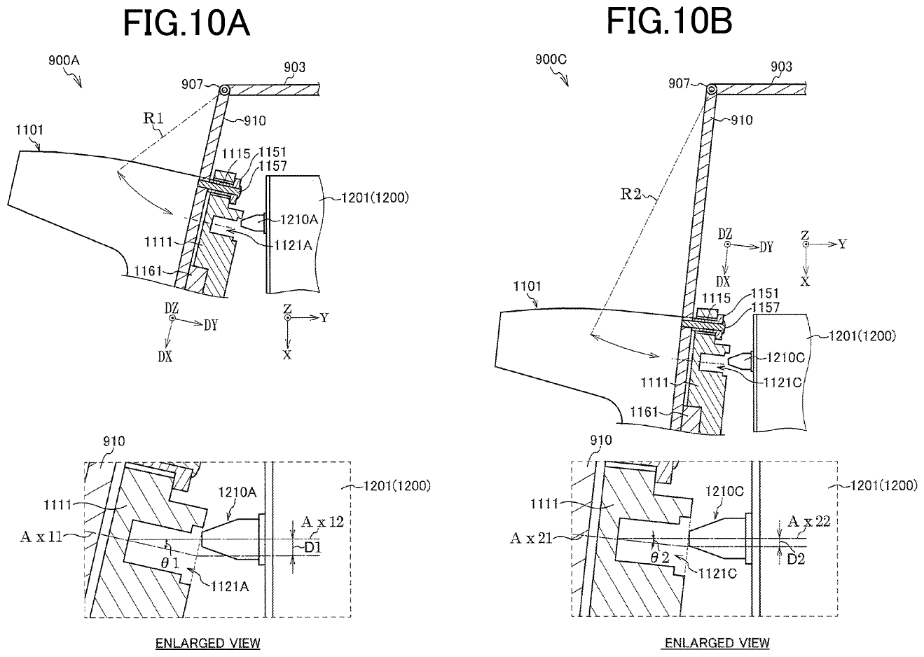

FIG. 10 are schematic diagrams and partial enlarged views thereof for explaining a relation between a pilot pin and a receiving hole at a time point when the receiving hole starts receiving the pilot pin, where FIG. 10A illustrates the embodiment of the present invention and FIG. 10B illustrates a comparative example.

In the banknote handling device 900 and a banknote handling device 900C illustrated in FIG. 10, pilot pins 1210 (1210A and 1210C) have linear central axes Ax12 and Ax22 and receiving holes 1121 (1121A and 1121C) have linear central axes Ax11 and Ax21. It is assumed that the both central axes (the central axes Ax12 and Ax11, the central axes Ax22 and Ax21) substantially align with each other when the pilot pin 1210 fits in the receiving hole 1121. In the banknote handling device 900C according to the comparative example, the positions of the pilot pin 1210C and the receiving hole 1121C are more distant from the hinge part 907 than in the banknote handling device 900 according to the embodiment of the present invention.

The door 910 is a hinged door that rotates about the hinge part 907 in an XY plane. Accordingly, the door 910 moves the receiving hole 1121 along an arc orbit. In other words, the door 910 does not linearly move the receiving hole 1121 along the central axis (Ax11, Ax21) of the receiving hole 1121. As the receiving hole 1121 is closer to the hinge part 907, a radius R of the orbit of the receiving hole 1121 is smaller (R1<R2).

An angle difference θ (θ1, θ2) between the central axes of the receiving hole 1121 and the pilot pin 1210 at a time point when the receiving hole 1121 starts receiving the pilot pin 1210 is larger as the receiving hole 1121 is closer to the hinge part 907 (θ1>θ2).

A position misalignment amount (D1, D2) between the receiving hole 1121 and the pilot pin 1210 at the time point when the receiving hole 1121 starts receiving the pilot pin 1210 is larger as the receiving hole 1121 is closer to the hinge part 907 (D1>D2).

From the above, it is understood that fitting of the pilot pin 1210 into the receiving hole 1121 is more difficult in FIG. 10A where the receiving hole 1121 and the pilot pin 1210 are closer to the hinge part 907 if the bezel bracket 1111 is fixed to the door 910.

### Effect

According to the embodiments of the present embodiment, when a pilot pin 1210 is brought into contact with an appropriate place of the corresponding receiving hole 1121 during a closing operation of the door 910, the adjuster 1150 can move the bezel bracket 1111 (the receiving hole 1121) in a direction to decrease the position misalignment amount D1. Therefore, the receiving holes 1121 (and the pilot pins 1210) can be formed closer to the hinge part 907 and the banknote separation transport device 1 can be downsized. Furthermore, since the adjuster 1150 appropriately changes the position misalignment amount according to the angular displacement of the door 910, the pilot pins 1210 smoothly fit in the corresponding receiving holes 1121.

In the present example in which the door 910 rotationally moves around the axis line extending in the Z-axis direction, the position misalignment amount D1 can be decreased when the bezel bracket 1111 is moved in a direction to approach the hinge part 907 from the initial position. It is possible that the movement of the bezel bracket 1111 is linear movement along the DX-axis.

According to the present embodiment, when a pilot pin 1210 is brought into contact with an appropriate place of the corresponding receiving hole 1121 during a closing operation of the door 910, the adjuster 1150 can move the bezel bracket 1111 (the receiving holes 1121) in a direction to decrease the angle difference θ1. Therefore, the receiving holes 1121 (and the pilot pins 1210) can be formed closer to the hinge part 907 and the banknote separation transport device 1 can be downsized. Furthermore, since the adjuster 1150 appropriately changes the angle difference according to the angular displacement of the door 910, the pilot pins 1210 smoothly fit in the corresponding receiving holes 1121.

In the present example in which the door 910 rotationally moves around the axis line extending in the Z-axis direction, the angle difference θ1 can be decreased when a portion of the bezel bracket 1111 near the hinge part 907 is caused to be close to the door 910 and a portion of the bezel bracket 1111 far from the hinge part 907 is caused to be away from the door 910.

### First Modification

In the first embodiment, the initial position of the bezel bracket 1111 is the neutral position. However, the initial position of the bezel bracket 1111 may be set to a position where at least one of the position misalignment amount D1 and the angle difference θ1 illustrated in FIG. 10A is decreased as compared to that at the neutral position, for example, minimized. In this case, the adjuster 1150 appropriately changes the position and the attitude of the bezel bracket 1111 with respect to the door 910 according to the angular displacement of the door 910, and smoothly fits the pilot pins 1210 in the corresponding receiving holes 1121.

### Second Modification

As illustrated in FIG. 10A, in the present example where the door 910 rotationally moves around the hinge part 907, the position misalignment amount D1 can be decreased when the bezel bracket 1111 can be moved in a direction to be brought closer to or farther from the hinge part 907. This movement may be one-dimensional movement on a line instead of two-dimensional movement in a plane.

That is, in the present example where the axis line of the hinge part 907 extends in the DZ-axis direction, desired effects are achieved by linearly moving the bezel bracket 1111 only in the DX-axis direction without moving the bezel bracket 1111 in the DZ-axis direction.

### Third Modification

As illustrated in FIG. 10A, the embodiment of the present invention is suitable in a case where each of the receiving holes 1121 has a configuration to receive the pilot pin 1210 in the axis line direction to be fitted therewith and where the orbit of the door 910 is different from the axis line direction of the pilot pins 1210 included in the banknote separation transport device body 1200.

As illustrated in FIG. 10 and the like, the direction in which the axis line of the hinge part 907 of the door 910 extends may be the Z-axis direction. Alternatively, the direction in which the axis line of the hinge part 907 of the door 910 extends may be the X-axis direction.

### Second Embodiment

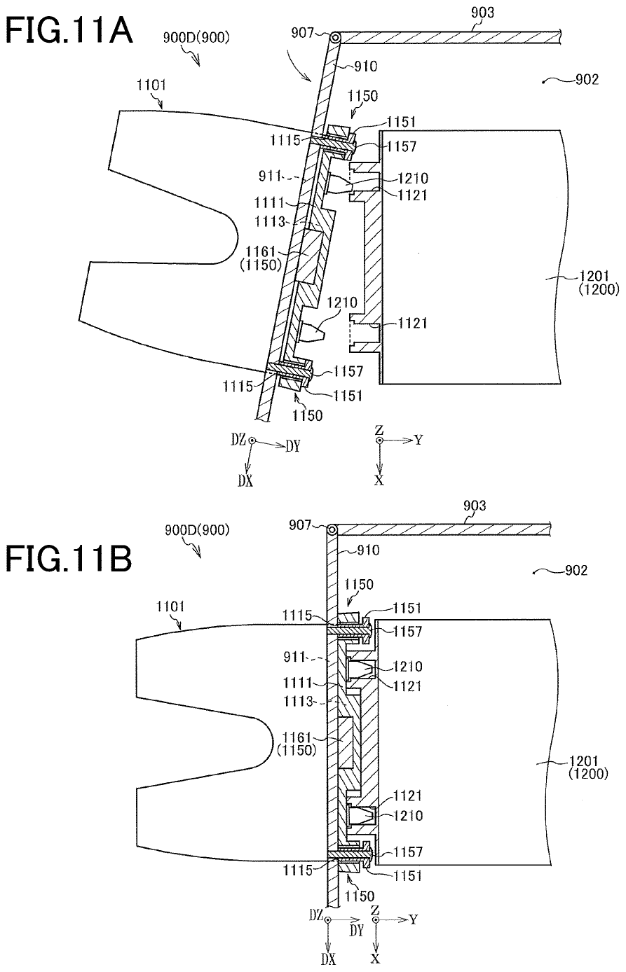

FIGS. 11A and 11B are explanatory diagrams of movement of the bezel at the time of a closing operation of the door in a second embodiment. Members substantially the same as those in the first embodiment are denoted with like reference signs and explanations thereof will be omitted.

In a banknote handling device 900D (900), the bezel bracket 1111 may include the pilot pins 1210, 1210 and the banknote separation transport device body 1200 may include the receiving holes 1211, 1121. Other configurations and operations are substantially the same as those in the first embodiment.

The present embodiment has effects substantially the same as those of the first embodiment.

### Third Embodiment

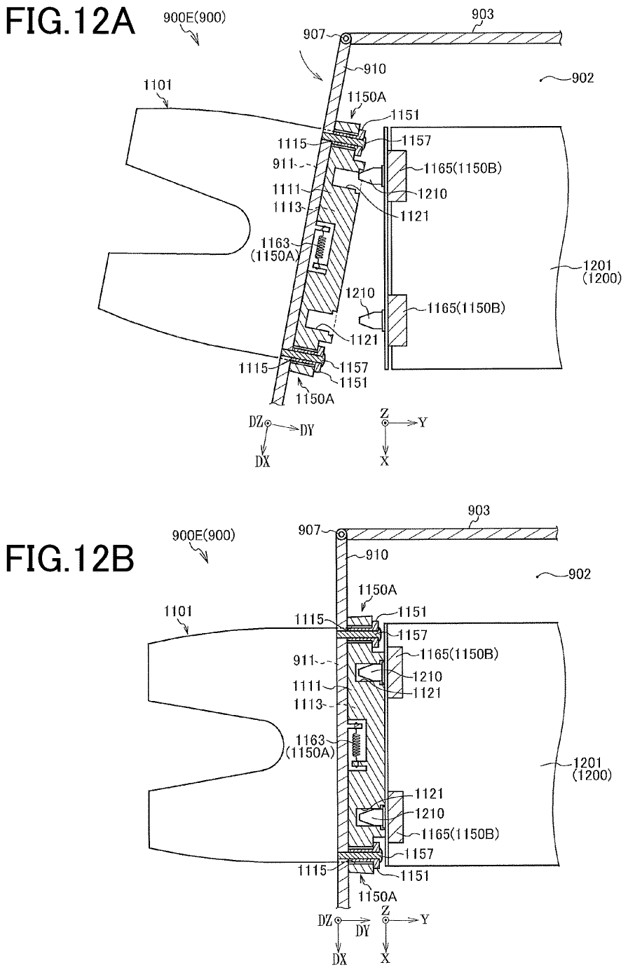

FIGS. 12A and 12B are explanatory diagrams of movement of the receiving holes and the pilot pins at the time of a closing operation of the door in a third embodiment. Members substantially the same as those in the first and second embodiments are denoted with like reference signs and explanations thereof will be omitted.

In a banknote handling device 900E (900), the adjuster 1150 includes an adjuster 1150A included in the bezel bracket 1111 and an adjuster 1150B included in the banknote separation transport device 1200.

The adjuster 1150A is a unit that moves the bezel bracket 1111 (the receiving holes 1121) in a DX-DZ plane. The adjuster 1150A includes the insertion holes 1115, and the flanged bushes 1151 that each loosely fit in the corresponding insertion hole 1115 described above. The adjuster 1150A further includes an elastic biasing member 1163 that elastically biases the bezel bracket 1111 to the initial position and that supports the bezel bracket 1111 to be movable in the DX-DZ plane.

The adjuster 1150B is a unit that moves back and forth the pilot pins 1210 in the Y-axis direction. The adjuster 1150B includes elastic biasing members 1165 that each elastically bias the corresponding pilot pin 1210 to the initial position. The adjuster 1150B is inserted between the front surface of the banknote separation transport device body 1200 and the pilot pins 1210. The elastic biasing members 1165 can be sponge as one example. The elastic biasing members 1165 also function as units that each elastically bias the corresponding pilot pin 1210 to the side of the door 910 when the door 910 is closed.

As described above, it is also possible to arrange some of functions of the adjuster 1150 on the door 910, and the others of the functions on the banknote separation transport device body 1200.

Of course, all the functions of the adjuster 1150 can be arranged on the banknote separation transport device body 1200. However, in a case where functions of the adjuster 1150 are arranged on the banknote separation transport device body 1200, it is desirable that the functions are limited to those that do not have great influences on positional alignment between the banknote input port 1103 and the banknote receiving port 1203 (see FIG. 5).

### Fourth Embodiment

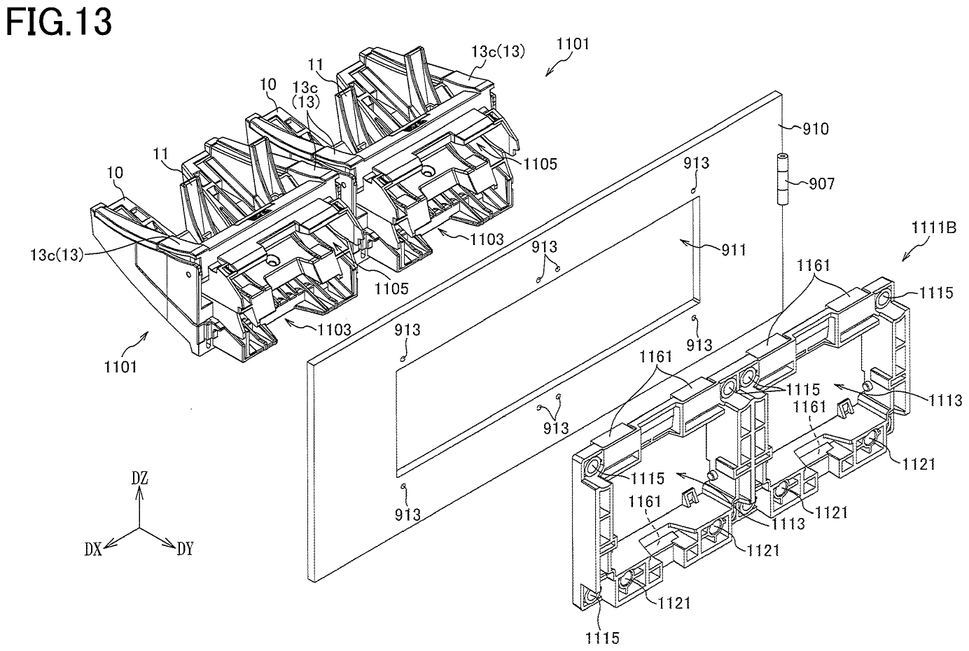

FIG. 13 is an exploded perspective view for explaining an attachment structure of the bezel to the door according to a fourth embodiment. In FIG. 13, illustrations of the flanged bushes 1151 and the fastening screws 1157 are omitted.

A bezel bracket 1111B includes a plurality of bracket openings 1113, 1113 and each of the bracket openings 1113, 1113 may be configured to support a corresponding one of bezel bodies 1101, 1101. Although not illustrated in FIG. 13, the banknote handling device 900 (see FIG. 5) in this case includes a plurality of BNF units 1201, 1201 respectively corresponding to the bezel bodies 1101, 1101. One banknote separation transport device body 1200 may include a plurality of BNF units 1201, or a plurality of banknote separation transport device bodies 1200 each including a BNF unit 120 may be housed in the enclosure 901.

In the case where one bezel bracket 1111B supports a plurality of bezel bodies 1101 in this manner, an attachment error that possibly occurs between each of the BNF units 1201 and a corresponding one of the bezel bodies 1101 can be absorbed by the bezel bracket 1111B. Particularly in a case where the bezel bodies 1101, 1101 arrayed in the X-axis direction are included as in the present example, in other words, a case where the bezel bodies 1101, 1101 at different distances from the hinge part 907 are included, it is effective to cause the bezel bracket 1111B to absorb an attachment error.

### Fifth Embodiment

In the embodiments described above, the present invention has been described based on the examples in which the bezel 1100 is moved mainly to align the banknote input port 1103 with the banknote receiving port 1203.

The bezel 1100 may be used to align the banknote return port 1105 with the banknote discharge port 1205.

The bezel 1100 may input or output paper sheets other than banknotes. For example, the bezel 1100 may output printed matters from a printer included in a paper sheet handling device body (corresponding to the banknote separation transport device body 1200).

The paper sheets to be handled by the paper sheet handling device body include bank drafts, invoices, checks, security documents, printed coupons, receipts, and other sheet-like objects, as well as banknotes. The paper sheets may be input or output one by one through the bezel 1100, or may be input or output in a state of a bundle (in a state where plural paper sheets are stacked).

### SUMMARY OF CONFIGURATION, ACTION, AND EFFECT OF PRESENT INVENTION

### First Aspect

A paper sheet handling device (a banknote handling device 900) according to the present aspect includes a bezel 1100 that has a paper sheet passing port (a banknote input port 1103 or/and a banknote return port 1105) allowing paper sheets (banknotes) to pass, and that is attached to a door 910 of an enclosure 901; a paper sheet handling device body (a banknote separation transport device body 1200) that has a paper sheet transfer port (a banknote receiving port 1203 or/and a banknote discharge port 1205) allowing the paper sheets to be transferred to/from the paper sheet passing port, and that is housed in the enclosure (an attachment part 902); and an adjuster 1150 that positionally adjusts the paper sheet passing port and the paper sheet transfer port to be communicated with each other in a normal positional relation during a closing operation of the door.

The paper sheet passing port of the bezel is an opening (the banknote input port 1103) to which paper sheets are input toward the paper sheet handling device body in some cases, and is an opening (the banknote return port 1105) through which paper sheets discharged from the paper sheet handling device body are caused to pass in other cases. The paper sheet transfer port of the paper sheet handling device body is a paper sheet receiving port (the banknote receiving port 1203) that receives paper sheets having been input from the opening of the bezel in some cases, and is a paper sheet discharge port (the banknote discharge port 1205) from which paper sheets are discharged toward the opening of the bezel in other cases.

In the present aspect, the adjuster adjusts the paper sheet passing port and the paper sheet transfer port to be communicated with each other in a normal positional relation in a process in which the door is operated in a closing direction.

According to the present aspect, the position of the bezel attached to the door of the paper sheet handling device can be aligned with the paper sheet handling device body.

In the present aspect, the bezel is attached to the door that performs an opening and closing operation.

It is assumed that the bezel is fixed to the paper sheet handling device body and an opening that exposes a tray part of the bezel to outside is formed on the door to penetrate therethrough. In this case, the size of the opening is set so as to prevent the tray part from hitting the opening at the time of opening and closing the door. Since the tray part is protruded from the paper sheet handling device body, the opening of the door needs to be formed sufficiently larger than the paper sheet passing port of the bezel.

In the present aspect, the bezel is attached to the door. Therefore, the opening on the door can be downsized and security is enhanced.

### Second Aspect

In the paper sheet handling device (the banknote handling device 900) according to the present aspect, the bezel 1100 is attached to be movable relative to the door 910. The bezel includes a first engaging part (receiving holes 1121). The paper sheet handling device body includes a second engaging part (pilot pines 1210) that holds the paper sheet passing port (the banknote input port 1103) and the paper sheet transfer port (the banknote receiving port 1203) in the normal positional relation when fitted in the first engaging part.

The present aspect is characterized in that the adjuster 1150 moves the bezel relative to the door to fit the first engaging part with the second engaging part when the first engaging part is brought into contact with the second engaging part during a closing operation of the door.

If the bezel is fixed to the door, fitting of the engaging parts becomes difficult depending on the movement direction of the door and the orientations of the first and second engaging parts.

According to the present aspect, the bezel moves relative to the door even when the first engaging part and the second engaging part are not in a positional relation in which these parts can be fitted with each other at a time point when the first engaging part is brought into contact with the second engaging part. This enables fitting of the first engaging part and the second engaging part with each other.

According to the present aspect, the position of the bezel attached to the door of the paper sheet handing device can be aligned with the paper sheet handling device body.

The second engaging part may be fixed to the paper sheet handling device body or may be supported to be movable relative to the paper sheet handling device body.

### Third Aspect

In the paper sheet handling device (the banknote handling device 900) according to the present aspect, the door 910 is a hinged door.

The door moves on a circular orbit around the hinge part 907. If the orbit of the door is arc-like, the following problems may occur (see FIG. 10). Firstly, the first engaging part (the receiving holes 1121) and the second engaging part (the pilot pins 1210) may interfere with each other and may be difficult to be fitted with each other depending on the orientations thereof. Secondly, if the positions of these engaging parts are set to positions sufficiently away from the hinge part to prevent the interference of these engaging parts, the paper sheet handling device (the enclosure 901) is increased in the size.

According to the present aspect, the bezel moves relative to the door upon contacting the first engaging part with the second engaging part. Therefore, even when the door is a hinged door, these engaging parts can be easily fitted with each other while increase in the size of the paper sheet handling device is prevented.

### Fourth Aspect

In the paper sheet handling device (the banknote handling device 900) according to the present aspect, the adjuster 1150 moves the bezel 1100 in a direction intersecting with a passage direction of the paper sheets (banknotes) (along a ZX plane, a DZ-DX plane).

In the present aspect, the door 910 is a hinged door that opens and closes the one-surface opening 905 of the enclosure 901 along a circular orbit. The direction in which the adjuster according to the present aspect moves the bezel can be a direction within a surface of the door 910. By setting the moving direction of the bezel in this manner, positional misalignment of the first engaging part and the second engaging part resulting from movement of the hinged door on a circular orbit can be absorbed.

According to the present aspect, the bezel moves relative to the door upon contact of the first engaging part with the second engaging part. Therefore, even when the door is a hinged door, these engaging parts can be easily fitted with each other while increase in the size of the paper sheet handling device is prevented.

### Fifth Aspect

In the paper sheet handling device (the banknote handling device 900) according to the present aspect, the adjuster 1150 moves back and forth the bezel 1100 along a passage direction of the paper sheets (in the Y direction, the DY direction).

In the present aspect, the door 910 is a hinged door that opens and closes the one-surface opening 905 of the enclosure 901 along a circular orbit. The direction in which the adjuster according to the present aspect moves the bezel can be a direction intersecting within the surface of the door 910. By setting the moving direction of the bezel in this manner, an angle difference between the first engaging part and the second engaging part resulting from movement of the hinged door on a circular orbit can be absorbed.

According to the present aspect, the bezel moves relative to the door upon contact of the first engaging part with the second engaging part. Therefore, even when the door is a hinged door, these engaging parts can be easily fitted with each other while increase in the size of the paper sheet handling device is prevented.

### Sixth Aspect

In the paper sheet handling device (the banknote handling device 900) according to the present aspect, the adjuster 1150 includes an elastic biasing member (an elastic biasing member 1161, 1163) that elastically biases the bezel 1100 to an initial position.

Upon contact of the first engaging part (the receiving holes 1121) with the second engaging part (the pilot pins 1210), the bezel moves relative to the door 910 from the initial position to a position where these engaging parts fit with each other. The initial position is set to a position where the first engaging part can be brought into contact with the second engaging part when the door is closed.

According to the present aspect, the bezel moves relative to the door upon contacting the first engaging part with the second engaging part. Therefore, the position of the bezel can be aligned with the paper sheet handling device body.

### Seventh Aspect

In the paper sheet handling device (the banknote handling device 900) according to the present aspect, the elastic biasing member (the elastic biasing member 1161) elastically biases the bezel 1100 to the paper sheet handling device body (the banknote separation transport device body 1200) when the door 910 is closed.

When the bezel is elastically biased to the paper sheet handling device body, the paper sheet passing port (the banknote input port 1103 or/and the banknote return port 1105) approaches the paper sheet transfer port (the banknote receiving port 1203 or/and the banknote discharge port 1205).

According to the present aspect, the paper sheets can be smoothly transferred between the paper sheet passing port and the paper sheet transfer port without occurring a jam.

Although the invention has been described in detail with reference to several embodiments, additional variations and modifications exist within the scope and spirit of the invention as described.

We claim:

1. A paper sheet handling device comprising:
a bezel comprising a paper sheet passing port allowing paper sheets to pass, said bezel attached to a door of an enclosure;
a paper sheet handling device body comprising a paper sheet transfer port allowing the paper sheets to be transferred to and from said paper sheet passing port, said paper sheet handling device body housed in said enclosure; and
an adjuster configured to positionally align said paper sheet passing port and said paper sheet transfer port during a closing operation of said door.

2. The paper sheet handling device according to claim 1, wherein said bezel is removably attached to said door, said bezel comprising a first engaging part;
said paper sheet handling device body comprising a second engaging part configured to hold said paper sheet passing port and said paper sheet transfer port in said aligned position when fitted in the first engaging part; and
said adjuster configured to cause said bezel to move relative to said door to fit said first engaging part with said second engaging part when said first engaging part is brought into contact with said second engaging part during a closing operation of said door.

3. The paper sheet handling device according to claim 1, wherein said door is a hinged door.

4. The paper sheet handling device according to claim 2, wherein said adjuster is configured to move said bezel in a direction intersecting with a passage direction of said paper sheets.

5. The paper sheet handling device according to claim 2, wherein said adjuster is configured to move said bezel back and forth along a passage direction of said paper sheets.

6. The paper sheet handling device according to claim 4, wherein said adjuster includes an elastic biasing member that elastically biases said bezel to an initial position.

7. The paper sheet handling device according to claim 5, wherein said adjuster includes an elastic biasing member that elastically biases said bezel to an initial position.

8. The paper sheet handling device according to claim 6, wherein said elastic biasing member elastically biases said bezel to said paper sheet handling device body when said door is closed.

9. The paper sheet handling device according to claim 7, wherein said elastic biasing member elastically biases said bezel to said paper sheet handling device body when said door is closed.

10. A paper sheet handling device comprising:
an enclosure including a door with an opening;
a bezel comprising a paper sheet passing port allowing paper sheets to pass, said bezel attached to said door such that a portion of said bezel passes through said opening;
a paper sheet handling device body comprising a paper sheet transfer port allowing the paper sheets to be transferred to and from said paper sheet passing port, said paper sheet handling device body housed in said enclosure; and
an adjuster configured to positionally align said paper sheet passing port and said paper sheet transfer port during a closing operation of said door.

11. The paper sheet handling device according to claim 10, wherein said bezel is removably attached to said door, said bezel comprising a first engaging part;
said paper sheet handling device body comprising a second engaging part configured to hold said paper sheet passing port and said paper sheet transfer port in said aligned position when fitted in the first engaging part; and
said adjuster configured to cause said bezel to move relative to said door to fit said first engaging part with said second engaging part when said first engaging part is brought into contact with said second engaging part during a closing operation of said door.

12. The paper sheet handling device according to claim 10, wherein said door is a hinged door.

13. The paper sheet handling device according to claim 11, wherein said adjuster is configured to move said bezel in a direction intersecting with a passage direction of said paper sheets.

14. The paper sheet handling device according to claim 11, wherein said adjuster is configured to move said bezel back and forth along a passage direction of said paper sheets.

15. The paper sheet handling device according to claim 13, wherein said adjuster includes an elastic biasing member that elastically biases said bezel to an initial position.

16. The paper sheet handling device according to claim 14, wherein said adjuster includes an elastic biasing member that elastically biases said bezel to an initial position.

17. The paper sheet handling device according to claim 15, wherein said elastic biasing member elastically biases said bezel to said paper sheet handling device body when said door is closed.

18. The paper sheet handling device according to claim 16, wherein said elastic biasing member elastically biases said bezel to said paper sheet handling device body when said door is closed.

19. A paper sheet handling device comprising:
an enclosure having a door with an opening;
a bezel comprising a paper sheet passing port allowing paper sheets to pass, said bezel configured to engage a paper sheet handling device body wherein said bezel is attached to said door and said paper sheet handling device body comprises a paper sheet transfer port allowing said paper sheets to be transferred to and from said paper sheet passing port, said paper sheet handling device body housed in said enclosure; and
an adjuster configured to positionally align said paper sheet passing port and said paper sheet transfer port during a closing operation of said door.

20. The paper sheet handling device according to claim 19, wherein said bezel is removably attached to said door, said bezel comprising a first engaging part;
said paper sheet handling device body comprising a second engaging part configured to hold said paper sheet passing port and said paper sheet transfer port in said aligned position when fitted in the first engaging part; and
said adjuster configured to cause said bezel to move relative to said door to fit said first engaging part with said second engaging part when said first engaging part is brought into contact with said second engaging part during a closing operation of said door.

21. The paper sheet handling device according to claim 19, wherein said door is a hinged door.

22. The paper sheet handling device according to claim 20, wherein said adjuster is configured to move said bezel in a direction intersecting with a passage direction of said paper sheets.

23. The paper sheet handling device according to claim 20, wherein said adjuster is configured to move said bezel back and forth along a passage direction of said paper sheets.

24. The paper sheet handling device according to claim 22, wherein said adjuster includes an elastic biasing member that elastically biases said bezel to an initial position.

25. The paper sheet handling device according to claim 23, wherein said adjuster includes an elastic biasing member that elastically biases said bezel to an initial position.

26. The paper sheet handling device according to claim 24, wherein said elastic biasing member elastically biases said bezel to said paper sheet handling device body when said door is closed.

27. The paper sheet handling device according to claim 25, wherein said elastic biasing member elastically biases said bezel to said paper sheet handling device body when said door is closed.
